(19) United States
(12) Patent Application Publication
(10) Pub. No.: US 2025/0091049 A1
(43) Pub. Date: Mar. 20, 2025

(54) Microfluidic Device for Analyzing Sample Material, and Method for Operating a Microfluidic Device

(71) Applicant: Robert Bosch GmbH, Stuttgart (DE)

(72) Inventor: Daniel Sebastian Podbiel, Rutesheim (DE)

(21) Appl. No.: 18/825,597

(22) Filed: Sep. 5, 2024

(30) Foreign Application Priority Data
Sep. 14, 2023 (DE) 10 2023 208 920.3

(51) Int. Cl. B01L 3/00

(52) U.S. Cl. CPC B01L 3/502753; B01L 2200/16; B01L 2300/0681; B01L 2300/087

(57) ABSTRACT

A microfluidic device for analyzing sample material is disclosed. The device features a microfluidic network. The network includes a first partial network for purifying sample material. In the first partial network, a first microfluidic pumping chamber and a second microfluidic pumping chamber are connected in series to a functional module for filtering sample material.

This application claims priority under 35 U.S.C. § 119 to patent application no. DE 10 2023 208 920.3, filed on Sep. 14, 2023 in Germany, the disclosure of which is incorporated herein by reference in its entirety.

### BACKGROUND

The disclosure is based on a microfluidic device for analyzing sample material and a method for operating a microfluidic device according to the disclosure below. The subject matter of the present disclosure is also a computer program.

Microfluidic analysis systems (so-called lab-on-chips (LoC for short)) enable automated, reliable, fast, compact and cost-effective processing of patient samples for medical diagnostics. By combining a variety of operations for the controlled manipulation of fluids, complex molecular diagnostic test sequences are performed in a lab-on-chip cartridge, which is also referred to as a microfluidic analysis device. Lab-on-chip cartridges, for example, can be produced cost-effectively from polymers using series production methods such as injection molding, punching or laser transmission welding. The processing of a lab-on-chip cartridge is performed in an associated analysis device. Various types of microfluidic analysis systems are known.

DE 10 2021 203 638 A1 discloses a corresponding microfluidic device for analyzing sample material, wherein the device comprises a first partial network for purifying sample material and a second partial network for amplifying sample material connected to the first partial network by a connection duct.

### SUMMARY

In light of this, with the approach presented here, a microfluidic device for analyzing sample material and a method for operating a microfluidic device, furthermore a control unit which uses this method, and finally a corresponding computer program are proposed according to the description below. Advantageous further developments of and improvements to the device specified below are made possible by the measures presented herein.

In general, a pressure-based microfluidic analysis device has at its disposal a variety of active microfluidic elements, such as valves and pumping chambers, which are interconnected in a suitable network of microfluidic ducts. The pneumatic control of the active microfluidic elements in turn is performed via pneumatic microducts within the microfluidic device, which can be pressurized or depressurized via an interface of the microfluidic analysis device, which is designed to be as compact as possible, to an analysis device, which can also function as a processing unit, in order to induce an actuation of the microfluidic elements by a corresponding deflection of an elastic membrane. In the design of such a microfluidic analysis device, the question therefore arises, in particular, of a particularly advantageous arrangement of the elements and configuration of the microfluidic network in order to be able to address a predetermined range of applications with the microfluidic device in a particularly advantageous manner. The microfluidic device presented here provides a particularly advantageous configuration of a microfluidic network with active pneumatically controllable elements for processing a sample liquid. Advantageously, the consumption of reagents required to perform a test run can be minimized, wherein at the same time particularly high reliability in microfluidic processing can be achieved.

A microfluidic device for analyzing sample material is presented, wherein the device features a microfluidic network, wherein the network comprises a first partial network for extracting and thereby purifying sample material, and optionally a second partial network for reproducing and thereby amplifying sample material.

If the microfluidic device comprises the second partial network, the first partial network and the second partial network can optionally be arranged in a linear topology. Furthermore, the partial networks can be separated from one another.

The first partial network comprises a first functional module for providing liquid reagents, a second functional module for adding a sample substance, a third functional module for filtering sample material, a fourth functional module for storing a liquid, and a first microfluidic pumping chamber, and a second microfluidic pumping chamber for producing a fluid transport. According to one particular configuration, the second and the fourth functional module can also be configured as a common functional module. The first microfluidic pumping chamber and the second microfluidic pumping chamber are connected in series to the third functional module for filtering sample material.

The optional second partial network comprises a first functional module for amplifying sample material and optionally a second functional module for dissolving at least one amplification reaction bead.

The microfluidic device can, e.g., be a lab-on-chip cartridge as part of a pressure based microfluidic analysis system. Liquid transport within the microfluidic analysis device can take place by applying, mostly pneumatic, pressure. The sample material, which can, e.g., originate from a sample substance added to the microfluidic device and processed within the microfluidic device, can, e.g., be a sample liquid. A sample substance can be understood as the sample which can be added into the cartridge, e.g. a liquid sample or a swab sample. In contrast, the sample material can in particular also only be components of the sample substance that were obtained from the sample substance, e.g. by extraction. For example, this sample liquid can be an aqueous solution, for example obtained from a biological substance, for example of human origin, such as a body fluid, a swab, a secretion, sputum, a tissue sample or a device with attached sample material. The sample liquid can contain, for example, species of medical, clinical, diagnostic or therapeutic relevance such as bacteria, viruses, cells, circulating tumor cells, cell-free DNA, proteins or other biomarkers or, in particular, components from the aforementioned object. For example, the sample liquid can be a master mix or components thereof, for example for performing at least one amplification reaction in the microfluidic analysis device, for example for DNA detection at the molecular level such as an isothermal amplification reaction or a polymerase chain reaction. For example, sample material can first be extracted in the device from an added sample substance, e.g. a liquid sample or swab sample. That is to say, sample material can be purified to enable subsequent amplification of components of the sample substance. The purification is particularly advantageous as the original sample substance can contain components, so-called inhibitors, which would adversely affect the amplification reaction. In the subsequent amplification reaction, only components of the original sample substance, such as certain DNA base sequences, can be amplified, that is, reproduced. For example, by applying positive or negative pressure locally, an elastic membrane as a component of the microfluidic device can be selectively deflected into recesses in the microfluidic device in order to draw liquid into the recesses or displace it from the recesses in this way. Due to the elastic membrane, a separation between the microfluidic, liquid-conducting areas of the device on the one hand, as well as the pneumatic areas and the external environment on the other hand, can be achieved hereby at the same time. For example, depending on the size of a recess in a liquid-conducting region and the associated displacement volume when the membrane is deflected into that region, there can be a microfluidic pumping chamber with a large displacement volume for the foreground generation of a flow in the device or a microfluidic valve with small displacement volume for the foreground control of the flow in the device. By a combination of a total of at least three microfluidic pumping chambers and additionally or alternatively valves, a directed flow in the microfluidic device can be produced by successive actuation of the elements. For example, a pumping chamber can be combined with two circumferential valves, that is, an inlet valve and an outlet valve, to achieve directed fluid transport. Moreover, for example, three similar elements with comparable displacement volumes can also be combined with each another to cause peristaltic fluid transport by successive actuations in series.

For example, the functional modules of the first partial network can be employed successively to purify or extract sample material. The first functional module can, e.g., provide liquid reagents in which, e.g., sample material can be dissolved and additionally or alternatively transported within the device. In the second functional module, a sample substance can be added, e.g. in the form of a sample liquid or a swab sample, and, if necessary, released from a carrier element, e.g. a sampling device. Using the third functional module, certain species can, e.g., be filtered out of the sample substance such that only the portion of the sample material to be analyzed can be transported further during the process. In the fourth functional module, liquid that accumulates during the purification of the sample substance can, e.g., be stored or temporarily retained. By way of the pump module, a liquid transport between the various functional modules and additionally or alternatively between the partial networks can be established. For example, after purifying the sample substance in the functional modules of the first partial network, a fluid enriched with sample material can then be transported through the connection duct from the first partial network to the second partial network. Sample material can in this case be, e.g., reproduced or amplified in the first functional module, while what is referred to as an amplification reaction bead can, e.g., be provided in a second functional module. Advantageously, the number of rinsing steps required to perform a test run within the microfluidic device can thus be reduced. In this way, the amount of time required to perform a test run can be reduced.

According to a further embodiment, the fourth functional module of the first partial network and the first functional module of the second partial network can be fluidically connected by the connection duct. For example, liquid accumulating during purification of the sample substance can be stored in the fourth functional module of the first partial network. Using the connection duct, a liquid with sample material can be transferred to the first functional module of the second partial network and sample material can subsequently be amplified. Advantageously, only connecting the two functional modules can simplify the separation of individual functional modules as well as the partial networks from each other, and the occurrence of cross-contamination between different process steps, that is to say undesirable mixing of different liquid solutions used during the execution of the test run, can be prevented.

The device presented here advantageously features a differentiation of the various functionalities that can be provided by the microfluidic device in the form of microfluidically separable partial networks. The term “partial network” can in this context be understood to mean a plurality of interconnected microfluidic elements. As mentioned above, the microfluidic elements can be passive elements, e.g. chambers or actuatable elements, e.g. pumping chambers, pumps, or valves. Preferably, a partial network comprises at least two, preferably more than two, fluidically connected microfluidic elements. The phrase “two separable partial networks” is in particular understood to mean that the two partial networks are arranged in two regions separated from each other locally and, in a preferable configuration, can be separated from each other by a planar cut. Alternatively or additionally, two separable partial networks can be understood to mean that the two partial network systems are connected to one another by one or more ducts, preferably only by one duct, wherein the ducts, or the duct, can preferably be fluidically separated from each another by at least one fluidic separating element, e.g., a valve.

Due to the separable partial networks, multiple control of microfluidic elements can be advantageously enabled, which can be associated with different partial networks. Furthermore, a separation of the performance of purification and amplification in separate partial networks enables a reduction in the number of rinsing steps as well as a suppression of an undesired microfluidic crosstalk between different sequence steps.

By arranging the first partial network and the second partial network in a linear topology, therefore the partial networks are arranged linearly or in series, a linear network topology is realized by the dead volumes that can occur when performing a test sequence within the microfluidic analysis device, can turn out particularly low. In this advantageous manner, the amount of reagents required to perform the test run within the microfluidic device can be reduced.

The functional modules of the first partial network and additionally or alternatively of the second partial network can be fluidly separable from one another. For example, each functional module can perform a particular task within a purification or analysis process and can have a variable number of individual elements such as valves, pumping chambers or storage chambers for this purpose. The individual functional modules can be separable from each other by way of, e.g., isolating valves. Furthermore, at least some of the functional modules can be arranged in a linear topology in a preferable configuration. The functional modules can, e.g., be successively controlled during a purification and analysis process to, e.g., first extract a species from a sample substance and then enable verification of the species or components thereof in separate regions of the microfluidic analysis device presented. Advantageously, this can prevent possible crosstalk, i.e., undesirable mixing of different liquid solutions, which can typically occur due to multiple use of certain regions of the microfluidic network. In this way, the efficiency of chemical reactions that occur within the microfluidic analysis device can be increased and the sensitivity which can be achieved in a verification process can be increased.

The first microfluidic pumping chamber and the second microfluidic pumping chamber can be used to provide fluid transport through the third functional module for filtering sample material. Furthermore, the two pumping chambers can be used to produce fluid transport through further functional modules of the first partial network and optionally the second partial network and/or fluid transport from the first partial network to the second partial network. According to one embodiment, the first partial network comprises no further pumping chamber or pumping device in addition to the first and the second microfluidic pumping chambers.

By connecting the two pumping chambers in series to the third functional module for filtering sample material, the two pumping chambers can be used together to generate a pressure difference between connections of the third functional module.

To this end, the device can feature a control connection for applying a first pressure to the first microfluidic pumping chamber and a control connection for applying a second pressure to the second microfluidic pumping chamber. The first pressure can cause the first microfluidic pumping chamber to be pressurized and the second pressure can cause the second microfluidic pumping chamber to aspirate. A large pressure difference can be created at the third functional module by combining the pressurization and aspiration. For example, the first pressure can be a positive pressure and the second pressure can be a negative pressure, in each case relative to an ambient pressure.

According to one embodiment, a first connection of the first microfluidic pumping chamber can be connected to the first functional module for providing liquid reagents and the second functional module for adding a sample substance. A second connection of the first microfluidic pumping chamber can be connected to a first connection of the third functional module for filtering sample material. A first connection of the second microfluidic pumping chamber can be connected to the second functional module for adding a sample substance. A second connection of the second microfluidic pumping chamber can be connected to a second connection of the third functional module for filtering sample material. Depending on the embodiment, the corresponding connections can be connected directly, therefore without a further intermediate element, or, for example, can be separated, for example via at least one intermediate microfluidic valve.

The third functional module can comprise a filter element, which can be separably connected to the first connection of the third functional module and separably connected to the second connection of the third functional module. In addition, the third functional module can comprise at least one microfluidic valve connected between the first and second connections of the third functional module. This allows the filter element to be bypassed. The filter element can be formed as a correspondingly known filter and allow for the extraction of constituents from a liquid.

The second functional module can comprise a sample input chamber for adding a sample substance. The sample input chamber can be separably connected to a first connection of the second functional module and separably connected to a second connection of the second functional module. The first connection of the first microfluidic pumping chamber can be connected to the first connection of the second functional module and the first connection of the second microfluidic pumping chamber can be connected to the second connection of the second functional module. Advantageously, the pumping chamber can also be used to transport a sample substance added to the sample input chamber through the first partial network.

According to one embodiment, the device can feature a common control connection for applying pressure, wherein the common control connection can be connected by a first control duct to an element of a functional module of the first partial network and by a second control duct to an element of a functional module of the second partial network. The element can, e.g., be a valve or pumping chamber or other microfluidic element of the device. For example, a positive or negative pressure can be applied to the common control connection, which can also be referred to as a port or control port, to control the elements of the functional modules of the partial networks. In this advantageous manner, multiple active elements, which each belong to different functional modules, can be switched via a common control duct. In other words, multiplexing is therefore possible during control. Multiplexing in the control of the active microfluidic elements can advantageously reduce the number of control ports needed to control a predetermined microfluidic network. In this way, the costs incurred for the analysis device, in particular the processing unit, can be reduced. In addition, multiplexing in the control of the active microfluidic elements can be used to realize a microfluidic network with an increased range of functions for a predetermined number of control ports. In this way, the range of application addressed by such a microfluidic analysis device can be extended.

According to a further embodiment, the fourth functional module of the first partial network can feature a first shutoff valve for closing the connection duct, and additionally or alternatively, the first functional module of the second partial network can feature a second shutoff valve for closing the connection duct. For example, the first shutoff valve can be kept closed while sample material is processed within the first partial network. This has the advantage that an undesirable premature intrusion of a transfer fluid with sample material used in the first partial network into the second partial network can be prevented. Similarly, after transport into the second partial network, where both shutoff valves can be open, closing the second shutoff valve can advantageously prevent backflow of the transfer fluid with the sample material into the first partial network.

According to a further embodiment, the device can comprise a valve control connection for applying a pressure, wherein the first shutoff valve and the second shutoff valve can be controlled by way of the valve control connection. For example, the first shutoff valve and the second shutoff valve can be simultaneously closed or opened by way of the valve control connection to enable or prevent fluid transfer between the first partial network and the second partial network of the device. Advantageously, the common control can reduce the number of control elements required for processing the device, thus reducing the cost of the system.

According to a further embodiment, the fourth functional module of the first partial network can be designed to output sample material. For example, if only purification and extraction of sample material is performed in the device, the sample material can be removed from the microfluidic device after performing an extraction, for example, without transferring it to the second partial network. For this purpose, the fourth functional module can, e.g., comprise an output mechanism used to output the sample material. Advantageously, the device can thereby be used variably for different analysis processes.

According to a further embodiment, the first partial network can feature an additional fourth functional module for storing a liquid. In this way, the area of application of the microfluidic analysis device can be extended.

According to a further embodiment, the device can comprise at least one further control connection for applying pressure, wherein the further control connection can be connected by a further control duct either to an element of a functional module of the first partial network or to an element of a functional module of the second partial network. The microfluidic device can, e.g., comprise a plurality of control connections, wherein some control connections can be designed to control multiple elements of various functional modules, while other control connections can be used to control a particular element of a functional module. Advantageously, such a precise control of all elements of the functional modules is possible.

Further presented is a method for operating a variant of the microfluidic device previously introduced, wherein the method comprises a step of extracting sample material using the first partial network, an optional step of transferring sample material from the first partial network into the second partial network, and an optional step of amplifying sample material using the second partial network.

The step of extracting comprises a substep of filtering, in which a pressure difference is generated on the third functional module by combined pressurization of the first microfluidic pumping chamber and aspiration with the second microfluidic pumping chamber to cause filtering of sample material.

According to one embodiment, the step of extraction can feature a substep of mixing and additionally or alternatively a substep of dissolving and additionally or alternatively a substep of lysis and additional or alternatively a substep of rinsing. Additionally or alternatively, the optional step of transfer can feature a substep of elution and additionally or alternatively, the optional step of amplification can feature a substep of dissolving and additionally or alternatively a substep of reproduction and additionally or alternatively a substep of acquisition.

For example, this method can be implemented in software or hardware, or in a mixed form of software and hardware, for example in a controller.

The approach presented here also creates a control unit which is designed to carry out, control or implement the steps of a variant of a method presented here in corresponding devices. The object of the present disclosure can also be achieved quickly and efficiently by way of this embodiment variant of the disclosure in the form of a control device. For example, the control unit can be used to pressurize the control connections of the microfluidic device with pressures suitable for operating the device.

For this purpose, the control device can feature at least one computing unit for processing signals or data, at least one memory unit for storing signals or data, at least one interface to a sensor or an actuator for reading in sensor signals from the sensor or for emitting control signals to the actuator, and/or at least one communication interface for reading in or emitting data embedded in a communication protocol. The computing unit may, for example, be a signal processor, a microcontroller or the like, wherein the memory unit can be a flash memory, an EEPROM, or a magnetic memory unit. The communication interface can be designed to read in or emit data in a wireless and/or wired manner, wherein a communication interface capable of reading in or emitting wired data can read in said data from a corresponding data transmission line, for example electrically or optically, or emit said data to a corresponding data transmission line.

In this context, the term “control unit” can be understood to mean an electrical device that processes sensor signals and emits control signals and/or data signals as a function thereof. The control unit can feature an interface, which can be designed as hardware and/or software. For example, given a hardware design, the interfaces can be part of what is referred to as an ASIC system, which contains a wide variety of functions for the control device. However, it is also possible that the interfaces are dedicated integrated circuits or consist at least partly of discrete components. When implemented as software, the interfaces can be software modules present, for example, on a microcontroller alongside other software modules.

Also advantageous is a computer program product or computer program with program code which is stored on a machine-readable carrier or storage medium, e.g., a semi-conductor memory, a hard disk memory, or an optical memory and used in order to perform, implement and/or control the steps of the method according to one of the embodiments described above, in particular if the program product or program is executed on a computer or a device.

### BRIEF DESCRIPTION OF THE DRAWINGS

Embodiment examples of the approach presented here are shown in the drawings and explained in greater detail in the following description.

FIG. 1 is a schematic representation of a microfluidic device;

FIG. 2 is a schematic representation of a microfluidic device;

FIG. 3 is a schematic representation of a microfluidic device;

FIG. 4 is a schematic representation of a microfluidic device;

FIG. 5 is a schematic representation of an embodiment example of a microfluidic device;

FIG. 6 is a schematic representation of an embodiment example of a microfluidic device;

FIG. 7 is a schematic representation of an embodiment example of a microfluidic device;

FIG. 8 is a schematic representation of an embodiment example of a microfluidic device;

FIG. 9 is a schematic top view of an embodiment example of microfluidic device;

FIG. 10 is a schematic top view of an embodiment example of microfluidic device;

FIG. 11 is a perspective top view of a section of the microfluidic device according to an embodiment example;

FIG. 12 is a perspective bottom view of a section of the microfluidic device according to an embodiment example;

FIG. 13 is a flow chart of a method 1000 for operating a microfluidic device according to an embodiment example;

FIG. 14 is a flow chart of a method 1000 for operating a microfluidic device according to an embodiment example;

FIG. 15 is a flow chart of a method 1000 for operating a microfluidic device according to an embodiment example;

FIG. 16 is a flow chart of a method 1000 for operating a microfluidic device according to an embodiment example; and

FIG. 17 is a schematic representation of an embodiment example of an analysis device for recording a microfluidic device.

### DETAILED DESCRIPTION

In the following description of advantageous embodiment examples of the present disclosure, identical or similar reference numbers are used for elements shown in the various drawings which have a similar function, wherein a repeated description of these elements has been omitted.

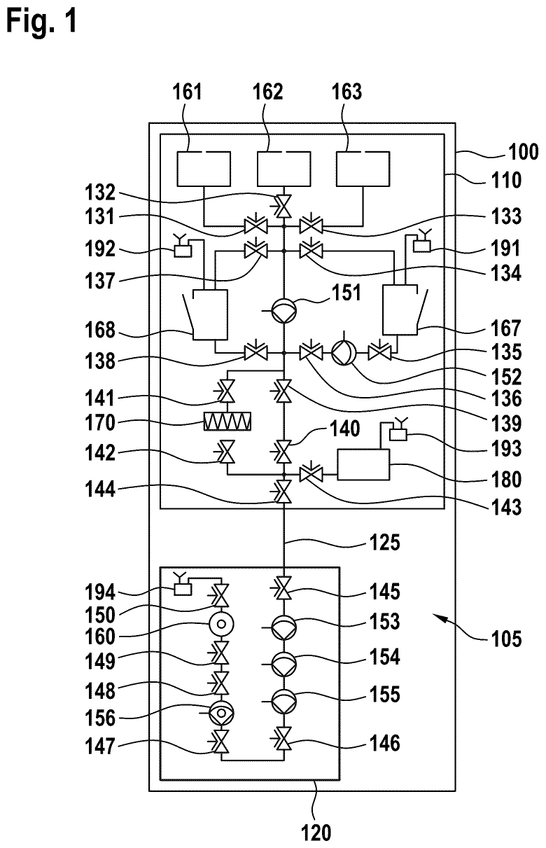

FIG. 1 shows a schematic view of a microfluidic device 100. The device 100 in this embodiment example features a microfluidic network 105, which has an optional linear topology. The network 105 is divided into a first partial network 110 and an optional second partial network 120, wherein both partial networks 110, 120 are marked by dashed lines in the illustration shown here.

Even if embodiment examples of the microfluidic device 100 with the two partial networks 110, 120 are shown in this and the following figures, the respective microfluidic device shown in each case can also be designed with only the first partial network 110, therefore either comprise no second partial network 120 or a differently designed second partial network.

If a corresponding microfluidic device, such as the microfluidic device 100 shown in FIG. 1 comprises both the first partial network 110 and the second partial network 120, the two partial networks 110, 120 are connected to each other via a microfluidic connection channel 125. Optionally, the first partial network 110 and the second partial network 120 are arranged in a linear topology. However, according to this and the embodiment examples shown in the following figures, a different arrangement of the partial networks 110, 120 is also possible.

Both the first partial network 110 and the second partial network 120 in this case comprise further microfluidic ducts that are shown as solid lines in the figure shown here in a schematic manner that connect different microfluidic elements to each other. In this embodiment example, the network 105 of the microfluidic device 100 is in particular characterized by 20 active microfluidic valves 131, 132, 133, 134, 135, 136, 137, 138, 139, 140, 141, 142, 143, 144, 145, 146, 147, 148, 149, 150. Only by way of example, two valves 144, 145 are arranged on the connection duct 125 and designed as a first shutoff valve 144 and a second shutoff valve 145 for closing the connection duct. The partial networks 110, 120 are therefore separable from one another. The network 105 also comprises six active microfluidic pumping chambers 151, 152, 153, 154, 155, 156, a passive microfluidic chamber 160, three pre-storage chambers with deaeration openings 161, 162, 163 for long-term stable pre-storage of liquid reagents, two sample input chambers 167, 168, which enable sample input, a filter element 170, which enables an extraction of components from a liquid, a liquid storage chamber 180, which serves to hold liquids after processing in the microfluidic network 105, as well as four deaeration devices 191, 192, 193, 194, which are used to deaerate the microfluidic network. In this embodiment example, the total of 26 active microfluidic elements can be controlled by pneumatic control ducts, as illustrated by the dashes branching perpendicular to the microfluidic ducts in the reference symbols. The arrangement and linkage of the specified elements forms the microfluidic network 105, which only has a linear topology (by way of example).

The microfluidic network 105 of the microfluidic device 100 is composed of the first partial network 110, which is provided for the purification of sample material, and the second partial network 120, which is provided for the amplification of sample material. The two partial networks 110, 120 are fluidically connected to each other via a microfluidic connection duct 125. As a result, microfluidic processing, within the context of the execution of a test run, can be performed successively, that is to say one after the other, within the two partial networks 110, 120. Accordingly, a combination of active microfluidic elements, which are each arranged in different partial networks 110, 120, can optionally be controlled by a common control duct.

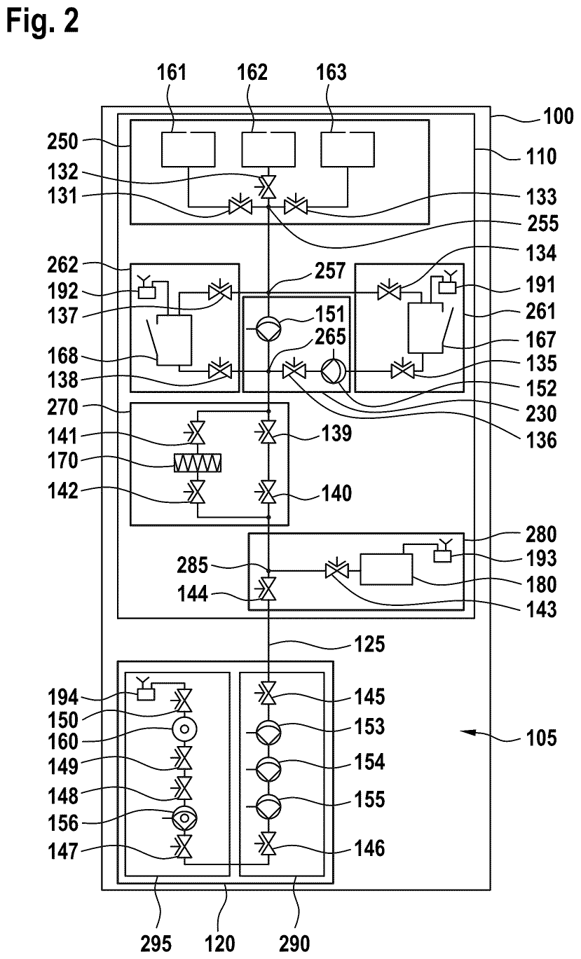

FIG. 2 shows a schematic view of a microfluidic device 100. The device 100 shown in this case corresponds to or resembles the device described in the preceding figure and comprises a microfluidic network 105 divided into a first partial network 110 and a second partial network 120. In this embodiment example, the microfluidic elements of the network 105 are arranged within the partial networks 110, 120 in a plurality of separable functional modules, wherein the individual functional modules are each marked by outlining rectangular boxes of dot-dashed lines in the illustration shown here. Specifically, in this embodiment example the partial network 110 for purifying sample material comprises a pump module 230 for transporting fluids and sample material dissolved therein within the network 105 or between the different functional modules. By way of example only, the pump module comprises two active microfluidic pumping chambers 151, 152 and a microfluidic valve 136 for this purpose. In addition, the first partial network 110 features a first functional module 250 for providing liquid reagents. By way of example only, arranged in this first functional module are only three pre-storage chambers 161, 162, 163 for a long-term stable pre-storage of liquid reagents. By way of example only, the liquid reagents are aqueous solutions, e.g., buffer solutions for processing a sample substance or components thereof. In another embodiment example, mineral oils, silicone oils, or fluorinated hydrocarbons can also be stored in the pre-storage chambers. In this embodiment example, each pre-storage chamber 161, 162, 163 is fluidically connected to a respective microfluidic valve 131, 132, 133, which in turn are fluidically connected to each other via a first duct interface 255 as well as to a second duct interface 257. By closing the valves 131, 132, 133, the first functional module 250 is separable from the remaining microfluidic network 105. Via the second duct interface 257, the first functional module 250 in this embodiment example is connected to the pump module 230, to a second functional module 261 for adding sample substances, and, by way of example only, to an additional second functional module 262 for adding sample substances. In this case, the second functional module 261 comprises a sample input chamber 167 with a deaeration device 191. The sample input chamber 167 is designed, by way of example, to receive a swab sample, that is to say a sampling device with attached sample material, and is fluidically connected to two valves 134, 135 within the second functional module. Similarly, the additional second functional module 262 comprises a sample input chamber 168 with a deaeration device 192 fluidically connected to two valves 137, 138. In this embodiment example, the sample input chamber 168 is in this case designed, by way of example only, to add a liquid sample. The second functional module 261 and the additional second functional module 262 are fluidically connected to the second duct interface via the valves 134, 137. Via the valves 135, 138, the second functional module 261 and the additional second functional module 262 are in turn fluidically connected to a third duct interface 265, via which there is a fluid connection to the pump module 230 and to a third functional module 270 for filtering the sample material, by way of example only. By closing the valves 134, 135, the second functional module 261 is separable from the remaining microfluidic network 105, just as the additional second functional module 262 is separable from the remaining microfluidic network 105 by closing the valves 137, 138. In this embodiment example, the third functional module 270 comprises, in addition to four microfluidic valves 139, 140, 141, 142, a filter element 170, which is an exemplary silica filter, and which is designed to filter species out of a sample substance, by way of example only. Closing the valves 139, 140, which are fluidically connected to the third duct interface 265 and a fourth functional module 280, in this case causes a fluid flow to be directed across the filter element 170. By closing the valves 139, 141, the third functional module 270 is separable from the functional modules 250, 261, 262 and the pump module 230, and by closing the valves 140, 142, the third functional module 270 is separable from the fourth functional module 280. The fourth functional module 280 in this embodiment example is designed to store a fluid used in the network 105. For this purpose, the fourth functional module 280 features, by way of example only, a liquid storage chamber 180 with a deaeration device 193 and two valves 143, 144. In another embodiment example, the fourth functional module 280 can additionally be designed to output sample material. In this embodiment example, the fourth functional module 280 is fluidically connected to the third functional module 270 and the connection duct 125 via a fourth duct interface 285. The valve 144 is in this case designed as a shutoff valve, by way of example only, and is arranged on the connection duct 125. By closing the valve 144, the entire first partial network 110 is therefore separable from the remaining microfluidic network 105. In this embodiment example, the connection duct 125 represents a fluidic connection between the fourth functional module 280 of the first partial network 110 and a first functional module 290 of the second partial network 120 for amplification of sample material. The first functional module 290 of the second partial network 120 is designed in this embodiment example to amplify sample material and comprises, by way of example only, three active microfluidic pumping chambers 153, 154, 155 arranged in a row, which, by way of example only, are bracketed by two microfluidic valves 145, 146. The valve 145 in this embodiment example is in the present case arranged directly on the connection duct 125 and designed as a shutoff valve. By closing the valve 145, the entire second partial network 120 is therefore separable from the remaining microfluidic network 105. In this embodiment example, the second partial network 120 also features a second functional module 295 with four valves 147, 148, 149, 150, an active microfluidic pumping chamber 156, a passive microfluidic chamber 160, and a deaeration device 194. The first functional module 290 and the second functional module 295 are fluidically connected to each other via the valves 146, 147. Separation of the two functional modules 290, 295 from each other is thus possible by way of the valve 146 of the first functional module 290 as well as by way of the valve 147 of the second functional module 295. The second functional module 295 of the second partial network 120 is provided, by way of example only, to provide at least one amplification reaction bead. By way of example only, the amplification reaction bead is a lyophilized or freeze-dried reagent used for producing an amplification reaction mix.

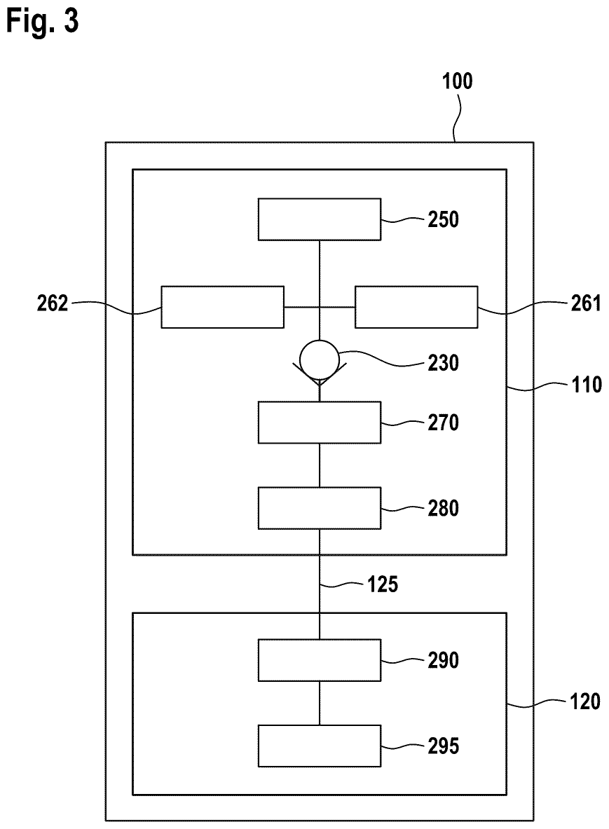

FIG. 3 shows a schematic view of a microfluidic device 100. The device 100 shown here corresponds to or is similar to the device described in the preceding Figures. In the illustration shown in this case, the functional modules 250, 261, 262, 270, 280, 290, 295 as well as the pump module 230 are shown in a simplified manner without the individual microfluidic elements. The functional modules 250, 261, 262, 270, 280, 290, 295 and the pump module 230 are arranged in a linear topology. Furthermore, the functional modules 250, 261, 262, 270, 280 as well as the pump module 230 are designed as components of the first partial network 110, and the functional modules 290, 295 as components of the second partial network 120, wherein the first partial network 110 and the second partial network 120 are connected to each other via exactly one connection duct 125. Due to the selected topology, it is only by way of example possible to reduce the size of the dead volumes, reduce the number of pumping steps, and to prevent undesirable microfluidic crosstalk between different process steps of a process.

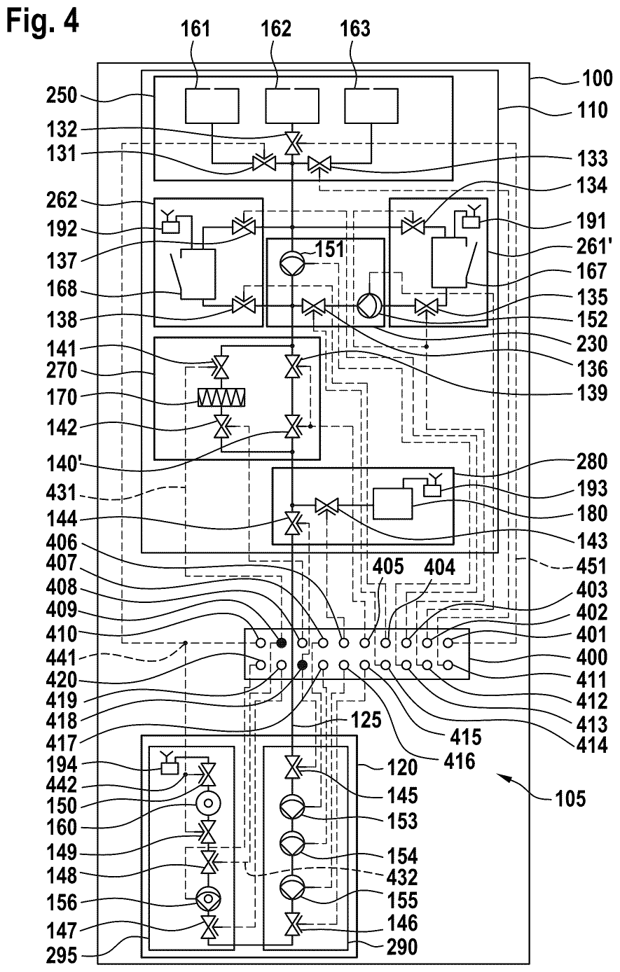

FIG. 4 shows a schematic view of a microfluidic device 100. The device 100 shown here corresponds to or is similar to the device with the network described in the preceding Figures. Furthermore, in addition to the microfluidic elements forming the network 105 of the microfluidic device 100, the control ducts used to control the active microfluidic valves 131, 132, 133, 134, 135, 136, 137, 138, 139, 140, 141, 142, 143, 144, 145, 146, 147, 148, 149, 150 and pumping chambers 151, 152, 153, 154, 155, 156 are also shown as dashed lines. In this particularly advantageous embodiment, control of these 26 active microfluidic elements 131, 132, 133, 134, 135, 136, 137, 138, 139, 140, 141, 142, 143, 144, 145, 146, 147, 148, 149, 150, 151, 152, 153, 154, 155, 156 is performed by way of a compact control interface 400. The control interface 400 comprises, by way of example only, 20 control connections 401, 402, 403, 404, 405, 406, 407, 408, 409, 410, 411, 412, 413, 414, 415, 416, 417, 418, 419, 420, which can also be referred to as control ports. The control ports in this embodiment example are pneumatic connections, via which an actuation of the active microfluidic elements 131, 132, 133, 134, 135, 136, 137, 138, 139, 140, 141, 142, 143, 144, 145, 146, 147, 148, 149, 150, 151, 152, 153, 154, 155, 156 occurs, by way of example only, by applying positive or negative pressure. As a result, a total of six-fold multiplexing is achieved, as results from the difference in the number of 26 elements and 20 ports. In the drawing shown in this case, the associated six branches of pneumatic control ducts, which enable multiplexing, are illustrated in the form of black nodes. The branching of the control ducts occurs either directly at a control connection or at a suitable point of a control duct. In the embodiment example shown, a branching takes place directly at the control connection 409, by way of example only. The control connection 409 is designed, by way of example only, to collectively control, through a first control duct 431, the valve 141 of the third functional module 270 of the first partial network 110 and, through a second control duct 432, the valve 148 of the second functional module 295 of the second partial network 120. Similarly, in this embodiment example, the first shutoff valve 144 and the second shutoff valve 145 can be controlled by way of a valve control connection 418 for applying pressure. As a result, opening or closing of the connection duct 125 using the valve control connection 418 is possible and the individual partial networks 110, 120 are separable from each another.

Conversely, a second control connection 410 in this embodiment example has a first branch 441 and a second branch 442, and is thus designed to collectively control both the valve 131 of the first functional module 250 of the first partial network 110 and the valves 149, 150 of the second functional module 295 of the second partial network 120. The control interface 400 also comprises a further control connection 401 for applying pressure, wherein the further control connection 401 in this embodiment example is connected to the valve 132 of the first functional module 250 of the first partial network 110 by a further control duct 451. By way of example only, a second further control connection 402 is connected to the pumping chamber 152 of the pump module 230 of the first partial network 110, a third further control connection 403 is connected to the valve 137 of the additional second functional module 262 of the first partial network 110, a fourth further control connection 404 is connected to the valve 138 of the additional second functional module 262 of the first partial network 110, a fifth further control connection 405 is connected to the valves 139, 140 of the third functional module 270 of the first partial network 110, a sixth further control connection 406 is connected to the valve 143 of the fourth functional module 280 of the first partial network 110, an eighth further control connection 408 is connected to the valve 142 of the third functional module 270 of the first partial network 110, an 11th further control connection 411 is connected to the valve 133 of the first functional module 250 of the first partial network 110, a 12th further control connection 412 is connected to the valves 134, 135 of the second functional module 261 of the first partial network 110, a 13th further control connection 413 is connected to the pumping chamber 151 of the pump module 230 of the first partial network 110, and a 14th control connection 414 is connected to the valve 136 of the pump module 230 of the first partial network 110. Similarly, elements of the second partial network 120 of the device 100 in this embodiment example can also be controlled by way of the control interface 400. By way of example only, a seventh further control connection 407 is thus connected to the pumping chamber 153 of the first functional module 290 of the second partial network 120, a 15th further control connection 415 is connected to the valve 146 of the first functional module 290 of the second partial network 120, a 16th further control connection 416 is connected to the pumping chamber 155 of the first functional module 290 of the second partial network 120, a 17th further control connection 417 is connected to the pumping chamber 154 of the first functional module 290 of the second partial network 120, a 19th further control connection 419 is connected to the valve 147 of the second functional module 295 of the second partial network 120, and a 20th further control connection 420 is connected to the pumping chamber 156 of the second functional module 295 of the second partial network 120.

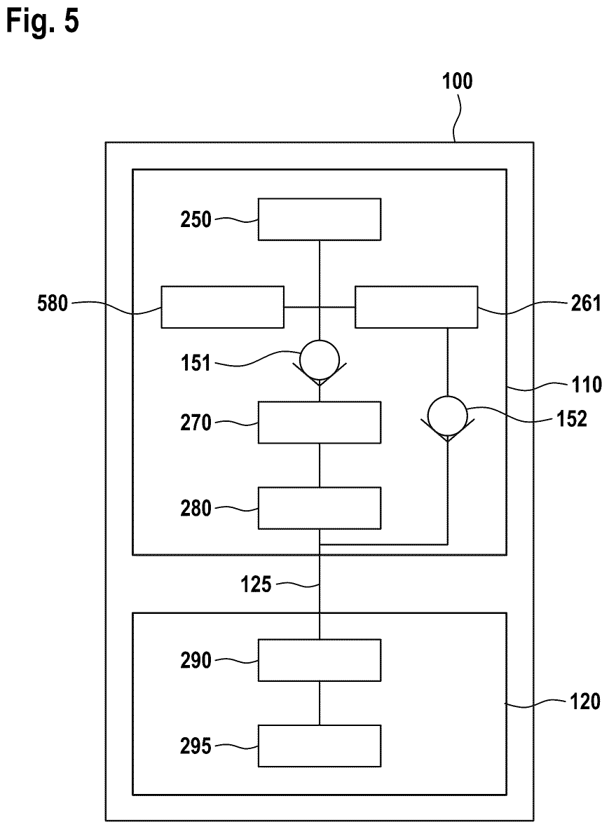

FIG. 5 shows a schematic representation of an embodiment example of a microfluidic device 100. The device 100 shown here corresponds to or is similar to the device described in the preceding Figures.

Optionally, in contrast to the device described with reference to FIG. 3, an additional fourth functional module 580 for storing a liquid is shown instead of an additional second functional module for adding sample substances.

In contrast to the device described with reference to FIG. 3, according to this embodiment example, a first microfluidic pumping chamber 151 and a second microfluidic pumping chamber 152 are used to transport liquid between the functional modules 250, 261, 270, 280, 290, 295, 580.

In the illustration shown in this case, the functional modules 250, 261, 270, 280, 290, 295, 580 are shown in a simplified manner without the individual microfluidic elements. The functional modules 250, 261, 270, 280, 290, 295, 580 are arranged in a linear topology. The functional modules 250, 261, 270, 280, 580 as well as the pumping chambers 151m 152 are designed as components of the first partial network 110, and the functional modules 290, 295 as components of the second partial network 120, wherein the first partial network 110 and the second partial network 120 are connected to each other via exactly one connection duct 125.

The first microfluidic pumping chamber 151 is connected between the first functional module 250 for providing liquid reagents and the third functional module 270 for filtering sample material. For example, a first connection of the first microfluidic pumping chamber 151 is coupled to a connection of the first functional module 250, a first connection of the second functional module 261, and a first connection of the additional fourth functional module 580. A second connection of the first microfluidic pumping chamber 151 is, by way of example, coupled to a first connection of the third functional module 270 and a second connection of the additional fourth functional module 580. Thus, the first microfluidic pumping chamber 151 is connected in parallel to the optional additional fourth functional module 580.

The second microfluidic pumping chamber 152 is connected between the second functional module 261 and a connection of the first partial network 110 coupled to the connection duct 125. For example, a first connection of the second microfluidic pumping chamber 152 is coupled to a second connection of the second functional module 261. A second connection of the second microfluidic pumping chamber 152 is connected, for example, to a connection of the fourth functional module 280 for storing a liquid.

In this way, a series connection between the microfluidic pumping chambers 151, 152 and the third functional module 270 is possible that allows the microfluidic pumping chambers 151, 152 to operate together to cause a pressure difference between the connections of the third functional module 270. For example, the first microfluidic pumping chamber 151 can be operated such that the first microfluidic pumping chamber 151 causes a positive pressure at the first connection of the third functional module 270. At the same time, the second microfluidic pumping chamber 152 can operate such that the second microfluidic pumping chamber 152 causes a negative pressure at the second connection of the third functional module 270.

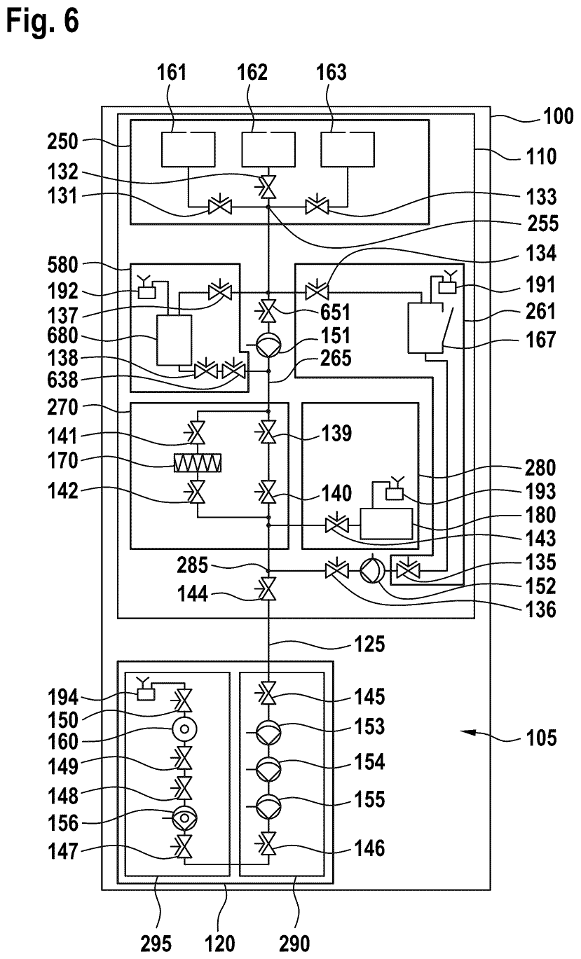

FIG. 6 shows a schematic representation of an embodiment example of a microfluidic device 100. The device 100 shown in this case corresponds to or resembles the device described in the preceding figure and comprises a microfluidic network 105 divided into a first partial network 110 and a second partial network 120. In this embodiment example, the microfluidic elements of the network 105 are arranged within the partial networks 110, 120 in a plurality of separable functional modules, wherein the individual functional modules are each marked by outlining rectangular boxes of dot-dashed lines in the illustration here.

The microfluidic device 100 substantially corresponds to the device described with reference to FIG. 2, wherein the substantial difference is the arrangement of the microfluidic pumping chambers 151, 152.

Optionally, in contrast to the device described with reference to FIG. 2, an additional fourth functional module 580 for storing a liquid is shown instead of an additional second functional module for adding sample substances. The additional fourth functional module 580 comprises an additional liquid storage chamber 680, a deaeration device 192, and, by way of example, three valves 137, 138, 638.

Specifically, in this embodiment example the partial network 110 for purifying sample material comprises a pump module for transporting fluids and sample material dissolved therein within the network 105 or between the different functional modules. By way of example only, the pump module comprises the two active microfluidic pumping chambers 151, 152 and microfluidic valves 136, 651 for this purpose.

In addition, the first partial network 110 features a first functional module 250 for providing liquid reagents. By way of example only, arranged in this first functional module are only three pre-storage chambers 161, 162, 163 for a long-term stable pre-storage of liquid reagents. By way of example only, the liquid reagents are aqueous solutions, e.g., buffer solutions for processing a sample substance or components thereof. In another embodiment example, mineral oils, silicone oils, or fluorinated hydrocarbons can also be stored in the pre-storage chambers. In this embodiment example, each pre-storage chamber 161, 162, 163 is fluidically connected to a respective microfluidic valve 131, 132, 133, which in turn are fluidically connected to each other via a first duct interface 255 as well as to a second duct interface 257. By closing the valves 131, 132, 133, the first functional module 250 is separable from the remaining microfluidic network 105.

Via the second duct interface 257, the first functional module 250 in this embodiment example is connected to the microfluidic valve 651, which is connected in series with the microfluidic pump chamber 151, to a second functional module 261 for adding sample substances, and, by way of example only, to the additional fourth functional module 580 for adding sample substances. A first connection of the first pumping chamber 151 is connected to the second duct interface 257 via the valve 651.

In this case, the second functional module 261 comprises a sample input chamber 167 with a deaeration device 191. The sample input chamber 167 is designed, by way of example, to receive a swab sample, that is to say a sampling device with attached sample material, and is fluidically connected to two valves 134, 135 within the second functional module 261.

The second functional module 261 and the additional fourth functional module 580 are fluidically connected to the second duct interface 257 via the valves 134, 137. Via the valves 138, 638, the additional fourth functional module 580 is in turn fluidically connected to a third duct interface 165, via which there is a fluid connection to the pumping chamber 151 and to a third functional module 270 for filtering the sample material, by way of example only. By closing the valves 134, 135, the second functional module 261 is separable from the remaining microfluidic network 105, just as the additional fourth functional module 262 is separable from the remaining microfluidic network 105 by closing the valves 137, 138, 638.

In this embodiment example, the third functional module 270 comprises, in addition to four microfluidic valves 139, 140, 141, 142, a filter element 170, which is an exemplary silica filter, and which is designed to filter species out of a sample substance, by way of example only. Closing the series-connected valves 139, 140 which are connected between the third duct interface 265 and a fourth duct interface 285, causes a fluid flow to be directed via the filter element 170. By closing the valves 139, 141, the third functional module 270 is separable from the functional modules 250, 261, 262 and the pump module 230, and by closing the valves 140, 142, the third functional module 270 is separable from the fourth functional module 280.

The fourth functional module 280 in this embodiment example is designed to store a fluid used in the network 105. For this purpose, the fourth functional module 280 features, by way of example only, a liquid storage chamber 180 with a deaeration device 193 and two valves 143, 144. In another embodiment example, the fourth functional module 280 can additionally be designed to output sample material. In this embodiment example, the fourth functional module 280 is fluidly connected to the fourth duct interface 285 via the second pumping chamber 252 and the valve 136.

Thus, the third functional module 270 for filtering sample material is connected between the third duct interface 265 and the fourth duct interface 285. A second connection of the first pumping chamber 151 is directly connected to the third duct interface 265 and a second connection of the second pumping chamber 152 is connected to the third duct interface 265 via the valve 136.

The fourth duct interface 285 is connected to the connection duct 125 via the valve 144, which is by way of example only. By closing the valve 144, the entire first partial network 110 is therefore separable from the remaining microfluidic network 105 and in particular from the second partial network 120. In this embodiment example, the connection duct 125 represents a fluidic connection between the fourth functional module 280 of the first partial network 110 and a first functional module 290 of the second partial network 120 for amplification of sample material.

The first functional module 290 of the second partial network 120 is designed in this embodiment example to amplify sample material and comprises, by way of example only, three active microfluidic pumping chambers 153, 154, 155 arranged in a row, which, by way of example only, are bracketed by two microfluidic valves 145, 146. The valve 145 in this embodiment example is in the present case arranged directly on the connection duct 125 and designed as a shutoff valve. By closing the valve 145, the entire second partial network 120 is therefore separable from the remaining microfluidic network 105. In this embodiment example, the second partial network 120 also features a second functional module 295 with four valves 147, 148, 149, 150, an active microfluidic pumping chamber 156, a passive microfluidic chamber 160, and a deaeration device 194. The first functional module 290 and the second functional module 295 are fluidically connected to each other via the valves 146, 147. Separation of the two functional modules 290, 295 from each other is thus possible by way of the valve 146 of the first functional module 290 as well as by way of the valve 147 of the second functional module 295. The second functional module 295 of the second partial network 120 is provided, by way of example only, to provide at least one amplification reaction bead. By way of example only, the amplification reaction bead is a lyophilized or freeze-dried reagent used for producing an amplification reaction mix.

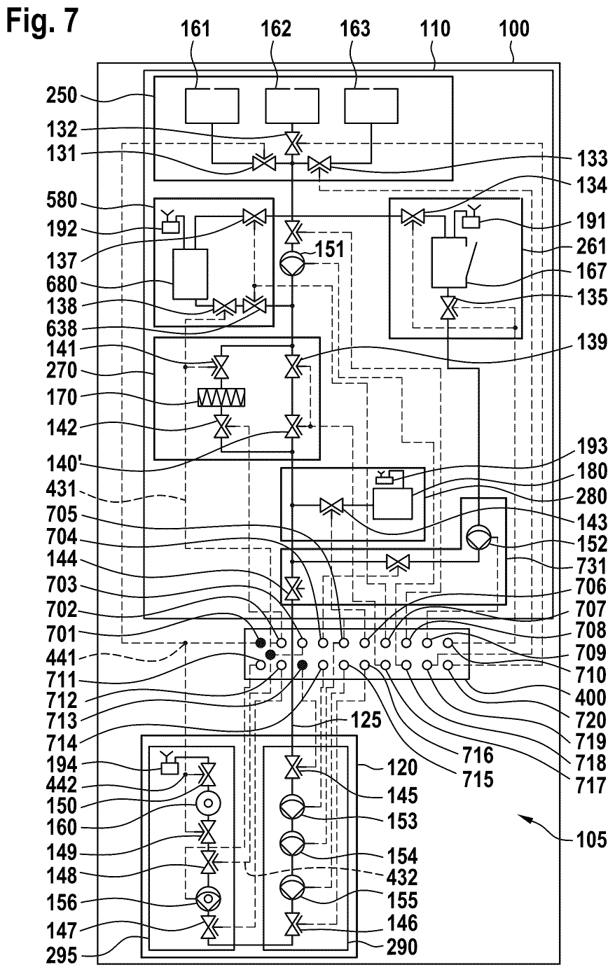

FIG. 7 shows a schematic representation of an embodiment example of a microfluidic device 100. The device 100 shown here corresponds to or is similar to the device with the network described in the preceding Figures. Furthermore, in addition to the microfluidic elements forming the network 105 of the microfluidic device 100, the control ducts used to control the active microfluidic valves 131, 132, 133, 134, 135, 136, 137, 138, 139, 140, 141, 142, 143, 144, 145, 146, 147, 148, 149, 150, 638, 651 and pumping chambers 151, 152, 153, 154, 155, 156 are also shown as dashed lines. In this embodiment, control of these active microfluidic elements 131, 132, 133, 134, 135, 136, 137, 138, 139, 140, 141, 142, 143, 144, 145, 146, 147, 148, 149, 150, 151, 152, 153, 154, 155, 156, 638, 651 is performed by way of a compact control interface 400. The control interface 400 only comprises, by way of example, twenty control connections 701, 702, 703, 704, 705, 706, 707, 708, 709, 710, 711, 712, 713, 714, 715, 716, 717, 718, 719, 720, which can also be referred to as control ports. The control ports in this embodiment example are pneumatic connections, via which an actuation of the active microfluidic elements 131, 132, 133, 134, 135, 136, 137, 138, 139, 140, 141, 142, 143, 144, 145, 146, 147, 148, 149, 150, 151, 152, 153, 154, 155, 156, 638, 651 occurs, by way of example only, by applying positive or negative pressure. This results in multiple multiplexing. In FIG. 7 shown in this case, the associated branches of pneumatic control ducts, which enable multiplexing, are illustrated in the form of black nodes. The branching of the control ducts occurs either directly at a control connection or at a suitable point of a control duct.

Thus, FIG. 7 shows a schematic representation of the network 105 of a further advantageous embodiment of the microfluidic analysis device 100 with a linear topology.

Comparable to the previous embodiment examples, the network 105 of the further embodiment of the microfluidic analysis device 100 is composed of microfluidic ducts that are schematically represented as solid lines connecting different microfluidic elements. In this further embodiment, the network 105 of the microfluidic analysis device 100 is characterized in particular by
twenty-two active microfluidic valves 131, 132, 133, 134, 135, 136, 137, 138, 139, 140, 141, 142, 143, 144, 145, 146, 147, 148, 149, 150, 638, 651,
six active microfluidic pumping chambers 151, 152, 153, 154, 155, 156,
one passive microfluidic chamber 160,
three pre-storage chambers 161, 162, 163 with deaeration openings for a long-term stable pre-storage of liquid reagents,
one chamber 167 allowing sample input,
one filter element 170 that allows for the extraction of constituents from a liquid,
two liquid storage chambers 180, 680, which are used for holding liquids after processing in the microfluidic network 105, and
three deaeration devices 191, 192, 193 that are used to deaerate the microfluidic network 105.

The total of twenty-eight active microfluidic elements 131, 132, 133, 134, 135, 136, 137, 138, 139, 140, 141, 142, 143, 144, 145, 146, 147, 148, 149, 150, 151, 152, 153, 154, 155, 156, 638, 651 can be controlled in this embodiment example by pneumatic control ducts, which are illustrated in FIG. 6 in each case by the lines branching off perpendicular to the microfluidic channels. A detailed schematic of this advantageous embodiment example of the microfluidic analysis device 100, including the configuration of the pneumatic drive channels, is shown in FIG. 7.

As in the previous embodiment variants, the arrangement and linking of the named elements to form the microfluidic network 105 is selected with a particularly advantageous linear topology. As shown in the Figures, the microfluidic network 105 of the microfluidic analysis device 100 is composed of a first partial network 110, which is provided for the purification of sample material, and a second partial network 120, which is provided for the amplification of sample material. The two partial networks 110, 120 are connected to each other via the microfluidic connection duct 210. As the microfluidic processing takes place successively, i.e. in succession, within the two partial networks 110, 120 during the performance of a test sequence, a combination of active microfluidic elements, which each belong to a different partial network 110, 120, can optionally be controlled by a common duct, without this resulting in a disadvantage for the microfluidic processing.

The schematic of this advantageous embodiment of the microfluidic device 100 outlined in FIG. 7 shows that in this embodiment example, in a particularly advantageous manner for controlling the twenty-eight active microfluidic elements 131, 132, 133, 134, 135, 136, 137, 138, 139, 140, 141, 142, 143, 144, 145, 146, 147, 148, 149, 150, 151, 152, 153, 154, 155, 156, 638, 651, only twenty pneumatic control ports 701, 702, 703, 704, 705, 706, 707, 708, 709, 710, 711, 712, 713, 714, 715, 716, 717, 718, 719, 720, can be used, wherein this can be realized via a total of eight branches of the pneumatic control ducts. The branch points of the pneumatic control ducts are illustrated schematically in FIG. 7, each by black circular nodes at the pneumatic control ducts drawn as dashed lines. This embodiment example thus illustrates that the selected configuration of the microfluidic device 100 according to the disclosure and the multiplexing when controlling the elements can provide a significant functional advantage, as only a reduced number of pneumatic control ports are needed for the actuation of the microfluidic elements and on the other hand, no significant limitations in microfluidic process control need be accepted due to the linear topology of the microfluidic network 105. Thus, the particularly advantageous configuration according to the disclosure can combine improved functionality with reduced effort for controlling the active microfluidic elements. Furthermore, a separation of the performance of purification and amplification in the separate partial networks 110, 120 advantageously enables a reduction in dead volumes, a reduction in the number of rinsing steps as well as a suppression of an undesired microfluidic crosstalk between different sequence steps.

The advantageous configuration of the microfluidic device 100 outlined in FIGS. 6 and 7 also allows a particularly variable pumping strategy to be chosen for the purification of a sample substance in the course of an extraction of constituents of the sample substance by the filter element 170.

In comparison to the first embodiment outlined in FIGS. 1 to 4, in the further embodiment shown in FIGS. 6 and 7, the two pumping chambers 151 and 152 are integrated into the microfluidic network 105 such that they are connected in series with the filter element 170. This enables, for example, improved pumping of a sample fluid via the filter element 170, in that a combined pressurization of the pumping chamber 151 with aspiration with the pumping chamber 152 such that there is a particularly high pressure difference in the microfluidic system when pumping a sample fluid via the filter element 170. In this way, for example, particularly high viscosity or viscous sample substances or inhomogeneous sample liquids with high viscosity sample constituents can be reliably pumped through the filter element 170 in an advantageous manner, for example to achieve extraction or accumulation of sample constituents on the filter element 170.

Furthermore, a microfluidic separation of the first pumping chamber 151 from the pre-storage chambers 161, 162, 163 and the sample input chamber 167 is implemented via at least two of the microfluidic valves 131, 132, 133, 134, 651 in each case, so that intrinsically a particularly reliable microfluidic separation of these fluid paths can be ensured in the event of pressurization of the microfluidic pumping chamber 151.

Further, in the detailed illustration in FIG. 7, the individual functional modules 250, 261, 270, 280, 290, 295, 580 forming the partial network 110, 120 of the microfluidic analysis device 100 are each characterized by encircling rectangular boxes:

Specifically, the partial network 110 to purify sample material consists of:
the first functional module 250 for providing the liquid reagents,
the second functional module 261 for adding a sample substance into the microfluidic device 100,
the third functional module 270 for filtering out species from the sample substance,
two fourth functional modules 280, 580 for storing liquids, and
two pump modules 730, 731 for producing liquid transport between the different functional modules.

The partial network 120 for amplification of sample material consists of:
the first functional module 290 for amplification, and
the second functional module 295 for providing an amplification reaction bead.

FIGS. 5 to 7 show in varying detail the arrangement of the functional modules 250, 261, 270, 280, 580 in the first partial network 110 for purification of sample material and the functional modules 290, 295 in the second partial network 120 for amplification of sample material in a linear topology in the further embodiment.

As described above, in this advantageous embodiment, the use of the two pump modules 151, 152, which are attached on both sides to the third functional module 270 for filtering out species from the sample substance, can enable improved pumping of a sample fluid via the filter element 170 in the first partial network 110 for purification of sample material.

For example, the control connection 718 is used to apply a first pressure to the first microfluidic pumping chamber 151 and the control connection 709 is used to apply a second pressure to the second microfluidic pumping chamber 152. Thus, the two pumping chambers 151, 152 can be controlled independently of each other.

The common control connection 703 is used, by way of example, to control the valves 138, 141 of the first partial network 110 via a first control duct passage 431 and the valve 148 of the second partial network 120 via a second control duct 432. Accordingly, the common control connection 701 is used both to control the first functional module 250 of the first partial network 110 and to control the second functional module 295 of the second partial network 120.

The valve control connection 713 is used to control the check valves 144, 145.

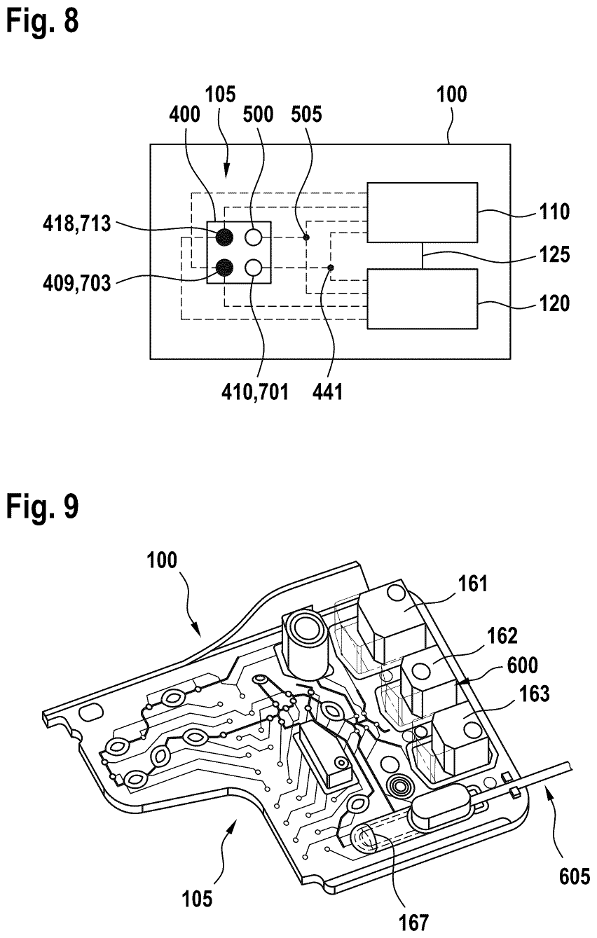

FIG. 8 shows a schematic representation of an embodiment example of a microfluidic device 100. The device 100 shown here corresponds to or is similar to the device described in the preceding Figures. For illustration, in the drawing shown in this case, the microfluidic network 105 is shown in a simplified manner. In this embodiment example, the microfluidic device 100 comprises two partial networks 110, 120 which are connected to each other via a microfluidic connection duct 125 and a pneumatic control interface 400 with four control connections 409, 410, 418, 500 or 701, 703, 713, 500. In this embodiment example, the control connections 409, 410, 418, 500, 701, 703, 713, 500 are each designed to control microfluidic elements of both the first partial network 110 and the second partial network 120. As a result of this four-fold multiplexing, a total of eight active microfluidic elements of the device 100 can be controlled in an advantageous manner by way of the four control connections, four of them per partial network 110, 120. The multiplexing is achieved by branching the control ducts at a total of four node points 409, 418, 441, 505 or 703, 713, 441, 505.

FIG. 9 shows schematic top view of an embodiment example of microfluidic device 100. The device 100 shown here corresponds to or is similar to the device described in the preceding Figures. In this embodiment example, the device 100 features a reagent bar 600 arranged within the three pre-storage chambers 161, 162, 163 with three compartments in each of which different liquid reagents can be pre-stored with long-term stability. Correspondingly, the pre-storage chambers 161, 162, 163 can also be referred to as reagent pre-storage chambers. In addition, within the sample input chamber 167 of the second functional module described in the preceding FIGS. 2 to 4, a sampling device 605 is arranged, by way of example only, to enable transfer of a swab sample thereon into the network 105 of the microfluidic device 100.

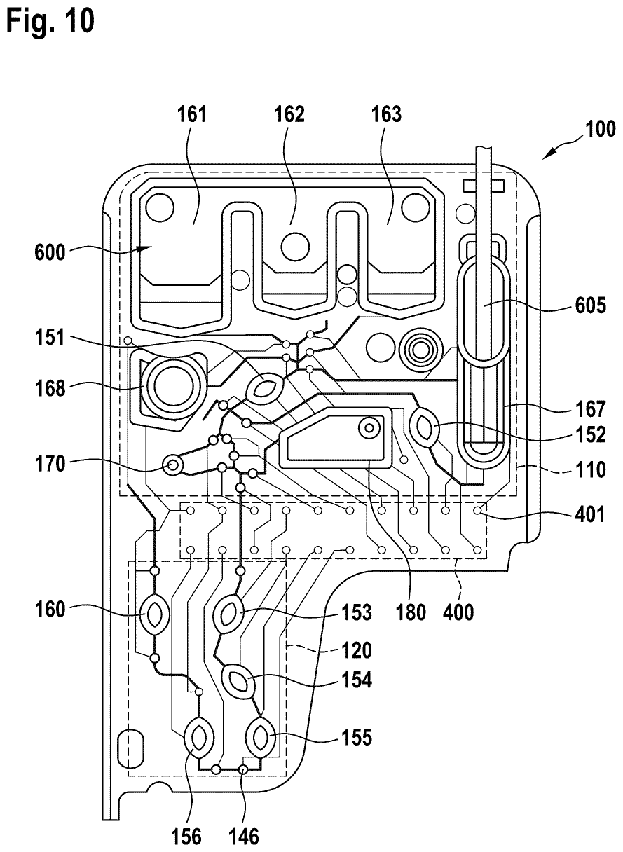

FIG. 10 shows a top view of an embodiment example of a microfluidic device 100. The device 100 shown here corresponds to or is similar to the device described in the preceding Figures. In the illustration shown in this case, some of the elements of the microfluidic device 100 described in the preceding drawings are numbered by way of example. Specifically, the microfluidic valve 146, the microfluidic pumping chambers 151, 152, 153, 154, 155, 156, the microfluidic chamber 160, the three pre-storage chambers 161, 162, 163, the two sample input chambers 167, 168, the microfluidic filter element 170, and the liquid storage chamber 180 are numbered. Furthermore, the first partial network 110 for purification of a sample substance, the second subnetwork 120 for amplification of sample material, and the pneumatic control interface 400 with an exemplarily numbered further control connection 401 are indicated by dashed lines. Merely by way of example, the device has an overall lateral dimension of 118×78 mm². In a further embodiment example, the overall dimension can be 50×25 mm² to 300×200 mm², preferably 75×25 mm² to 200×100 mm². In this embodiment example, the fluidic and pneumatic microducts also have a cross-sectional dimension of only 600×400 μm², by way of example only. In a further embodiment example, the cross-sectional dimensions of the fluidic and pneumatic microducts can be 100×100 μm² to 3×3 mm², preferably 300× 300 μm² to 1×1 mm². The effective displacement volume of a microfluidic pumping chamber in this embodiment example is 20 μl, the effective displacement volume of a microfluidic valve is only 125 nl, and the volume of the microfluidic chamber with filter element in this embodiment example is only 8 μl. In other embodiment examples, the effective displacement volume of a microfluidic pumping chamber can be from 1 μl to 50 μl, preferably from 5 μl to 30 μl, the effective displacement volume of a microfluidic valve can be 50 nl to 1 μl, preferably 100 nl to 300 nl, and the volume of the microfluidic chamber with filter element can be 3 μl to 20 μl, preferably 5 μl to 10 μl. In this embodiment example, for microfluidic processing within the device 100, a pressure difference (positive pressure or negative pressure relative to atmospheric pressure), which is used to generate the microfluidic flow by pressuring or aspirating by way of a pumping chamber or controlling the microfluidic flow by way of a valve, of 700 mbar is applicable, by way of example only. In a further embodiment example, the pressure difference can be 100 mbar to 2000 mbar, preferably 400 mbar to 1500 mbar.

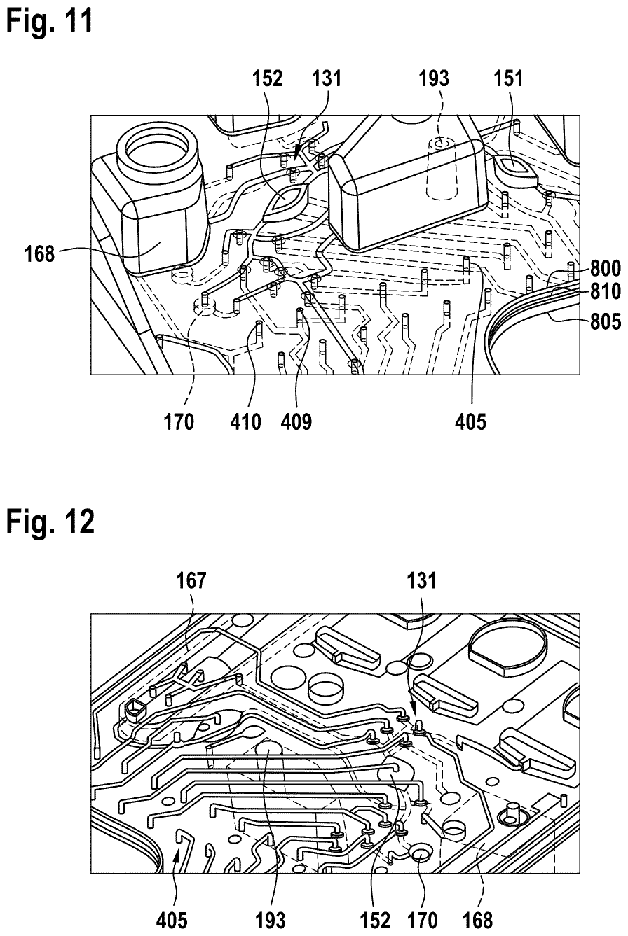

FIG. 11 shows a perspective top view of a section of the microfluidic device 100 according to an embodiment example. The device 100 shown here corresponds to or is similar to the device described in the preceding Figures. In the drawing shown in this case, by way of example, the microfluidic valve 131, the microfluidic pumping chambers 151, 152, the sample input chamber 168, the microfluidic chamber with the filter element 170, the deaeration device 193, and the pneumatic control connections 405, 409, 410 are numbered. The microfluidic device 100 in this embodiment example is realized by two rigid polymeric components, 800, 805, connected to each other via a flexible membrane 810. The lower polymer component 800 is terminated by another polymer film to seal the microducts present in the polymer component. The multi-layer construction thus enables in particular the realization of fluidic and pneumatic microducts on at least two different lateral planes. In this way, fluidic and pneumatic microducts are crossable and a particularly high degree of integration of the microfluidic device 100 can be achieved with a central and particularly compact configuration of the pneumatic control interface described in FIG. 4. By applying positive or negative pressure to the pneumatic control connections, the flexible polymer membrane can be deflected in recesses present on the microfluidic valves and pumping chambers via the pneumatic microducts in order to achieve the opening or closing of a microfluidic valve or a pumping chamber. By pumping out or expelling liquid by way of a pumping chamber, the microfluidic flow within the network 105 can be precisely controlled when the valve is in a suitable position. In other embodiment examples, e.g., the following materials can be used for the realization of the microfluidic analysis device: Primarily polymers such as polycarbonate (PC), polystyrene (PS), styrene-acrylonitrile copolymer (SAN), polypropylene (PP), polyethylene (PE), cycloolefin copolymer (COP, COC), polymethyl methacrylate (PMMA), polydimethylsiloxane (PDMS) or thermoplastic elastomers (TPE) such as polyurethane (TPU) or styrene block copolymer (TPS). The device can be manufactured, e.g., by series production methods like injection molding, compression molding, thermoforming, punching or laser transmission welding.

FIG. 12 shows a perspective bottom view of a section of the microfluidic device 100 according to an embodiment example. The device 100 shown here corresponds to or is similar to the device described in the preceding Figures. In the drawing shown in this case, by way of example, the microfluidic valve 131, the microfluidic pumping chambers 151, 152, the sample input chambers 167, 168, the microfluidic chamber with the filter element 170, the deaeration device 193, and the pneumatic control port 405 are numbered.

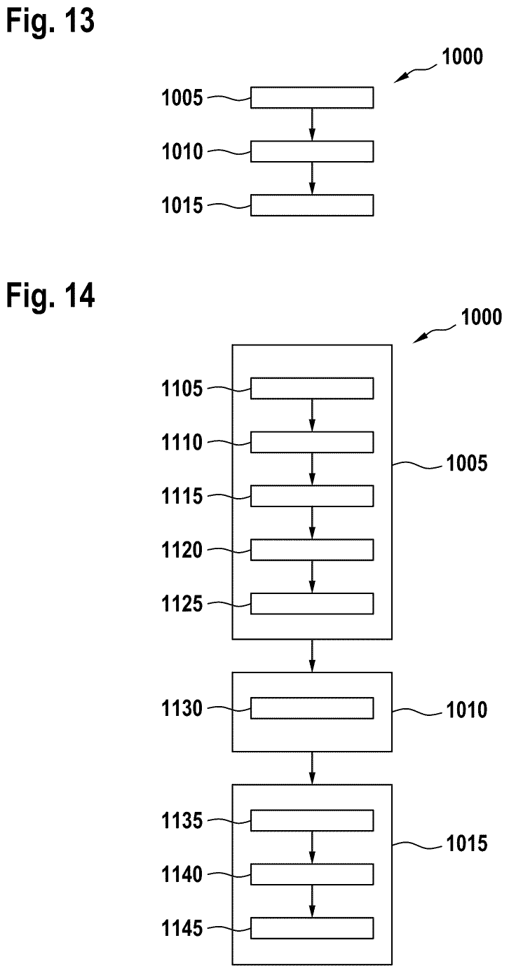

FIG. 13 shows a flow chart of a method 1000 for operating a microfluidic device according to an embodiment example. The device operated using the method can be the device described in the preceding drawings. The method 1000 comprises a step 1005 of extracting sample material using the first partial network. By way of example only, a sample substance is purified in the partial network and sample material, e.g. DNA or RNA, is extracted from the sample substance and transferred to the microfluidic network. This is followed by an optional step 1010 of transferring sample material from the first partial network to the second partial network, wherein a solution containing previously extracted sample material is transferred from the first partial network to the second partial network. In the following optional step 1015 of amplification sample material using the second partial network, sample material is amplified in the second partial network and thus made accessible for, e.g., fluorometric verification. In a further embodiment example of the method 1000, the step 1005 of extraction or the steps 1010, 1015 of transfer and amplification can be omitted. For example, the first step 1005 of extraction can be omitted if the species being verified is already present in extracted form in an added sample liquid. The second step 1010 of transfer and the third step 1015 of amplification can be omitted, e.g., if only purification or extraction of sample material is performed in the device and the sample material is removed from the microfluidic device again, e.g. after performing the first step 1005 of extraction.

FIG. 14 shows a flow chart of a method 1000 for operating a microfluidic device according to an embodiment example. The method 1000 shown in this case corresponds or is similar to the method described in the preceding FIG. 13 with the difference that the individual steps 1005, 1010, 1015 have additional substeps. In this embodiment example, the step 1005 of extraction comprises a substep 1105 of mixing, and a substep 1110 of dissolving, and a substep 1115 of lysis, and a substep 1120 of filtering, and a substep 1125 of rinsing. In this embodiment example, the step 1010 of transfer comprises a substep 1130 of elution and the step 1015 of amplification comprises a substep 1135 of dissolving, and a substep 1140 of reproduction, and a substep 1145 of acquisition. In the substep 1105, mixing of a liquid sample added into the sample input chamber is performed, only by way of example, using a binding buffer. The mixing is performed in particular using the first functional module, the additional second functional module, the pump module and a plurality of the following elements: microfluidic valves, microfluidic pumping chambers, a sample input chamber and a deaeration device. In this embodiment example, the binding buffer is upstream in exactly one of the three pre-storage chambers of the first partial network. In this embodiment example, the adjacent functional modules comprise microfluidic valves, which are closed in this substep 1105, such that undesirable microfluidic crosstalk with the adjacent functional modules is prevented.

In the substep 1110 of dissolving, in this embodiment example sample material is dissolved within the sample input chamber, which is initially present and attached to a sampling device added to the sample input chamber. Dissolving is performed, by way of example only, by way of a transfer liquid introduced into the chamber, in particular using the first and second functional modules and the pump module and a plurality of the following elements: microfluidic valves, microfluidic pumping chambers, pre-storage chambers, a sample input chamber and a deaeration device. The transfer liquid is upstream in precisely one of the pre-storage chambers, by way of example only. The adjacent functional modules comprise in particular microfluidic valves, which are closed in this substep 1110 such that undesirable microfluidic crosstalk with the adjacent functional modules is prevented.

In the substep 1115 of lysis, in this embodiment example a lysis buffer is added to a sample substance added to at least one of the sample introduction chambers, and the sample substance or components thereof are tempered to effect thermally induced lysis of components of the sample substance. The components of the sample substance to be lysed in this substep 1115 are bacteria, by way of example only. In another embodiment example, e.g., these can be other cells. Lysis is performed in particular using the first, second and additional second functional modules and the pump module, as well as a plurality of the following elements: microfluidic valves, microfluidic pumping chambers, pre-storage chambers, a sample input chamber and a deaeration device. The lysis buffer is upstream in precisely one of the pre-storage chambers, by way of example only. The adjacent functional modules comprise in particular microfluidic valves, which are closed in this substep 1115, such that undesirable microfluidic crosstalk with the adjacent functional modules is prevented. In an alternative embodiment example of the substep 1115 of lysis, thermally induced lysis of components of the sample substance can be performed by tempering the filter element after the components of the sample substance have been enriched on the filter element. during the substep 1120 of filtering.

During the substep 1120 of filtering, in this embodiment example, a filtering and binding of components of the sample substance added to at least one of the sample input chambers is performed using the filter element such that the components of the sample substance are enriched on the filter element. Filtering is performed in particular using the third, fourth, second or additional second functional modules or the pump module(s), as well as a plurality of the following elements: microfluidic valves, microfluidic pumping chambers, a pre-storage chamber, the filter element, the sample input chamber and a deaeration device. The adjacent functional modules comprise in particular microfluidic valves, which are closed in this substep 1120 such that undesirable microfluidic crosstalk with the adjacent functional modules in this substep is prevented. For example, a binding buffer with sample material from one of the sample input chambers is pumped by way of the filter element into the liquid storage chamber, wherein components of the sample material, for example DNA or RNA, are attached and concentrated on the filter element. The substep 1120 of filtering is performed in this embodiment example after a performance of the substep 1105 of mixing, the substep 1110 of dissolving and the substep 1115 of lysis. In another embodiment example, the substep 1120 of filtering can occur prior to or after the substep of lysis depending upon the exact embodiment of the method: If lysis occurs in one of the sample input chamber, then the substep of filtering can be performed after the substep of lysis. If lysis occurs on the filter element, on the other hand, the substep of filtering can be performed prior to the substep 1115 of lysis.

In the substep 1125 of rinsing, in this embodiment example, the microfluidic network is rinsed with a wash buffer, e.g. to eliminate residues of the binding buffer present in the microfluidic network after the substep 1120 of filtering. Rinsing is performed in particular using the first, third, and fourth functional modules, as well as the pump module and a plurality of the following elements: microfluidic valves, microfluidic pumping chambers, pre-storage chambers, the liquid storage chamber, and a deaeration device. The wash buffer is upstream in precisely one of the pre-storage chambers, by way of example only.

In the substep 1130 of elution, in this embodiment example, sample material present on the filter element is dissolved in order to make it accessible for molecular diagnostics verification by way of an amplification reaction. The sample material is DNA, by way of example only, in another example, it can also be RNA. To this end, an elution buffer is pumped over the filter element to transfer sample material present on the filter element to the elution buffer, by way of example only. In connection with the elution, in this embodiment example, the elution buffer is also transferred with sample material from the first partial network to the second partial network via the microfluidic connection duct. The elution is performed in particular using the first, third, and fourth functional modules of the first partial network, as well as the first functional module of the second partial network and the pump module as well as a plurality of the following elements: microfluidic valves, microfluidic pumping chambers, microfluidic connection duct, pre-storage chambers, liquid storage chamber, and a deaeration device. The elution buffer is upstream in precisely one of the pre-storage chambers, by way of example only.

In the substep 1135 of dissolving, in this embodiment example the elution buffer is employed with the sample material contained in order to dissolve a freeze-dried or lyophilized reagent, which can also be referred to as reaction bead, and in this way provide a reaction mix for a subsequent amplification reaction. By way of example only, this is a master mix for performing a polymerase chain reaction. Dissolving is performed in particular using the first and second functional module of the second partial network as well as a plurality of the following elements: microfluidic valves, microfluidic pumping chambers, microfluidic chamber, and the deaeration device. In this embodiment example, the freeze-dried or lyophilized reagent or reaction bead is present in a pumping chamber or the passive microfluidic chamber. Pumping of the elution buffer with sample material into at least one of the elements for dissolving the reaction bead is performed in this embodiment example using pumping chambers. After releasing the reaction bead, by way of example only, the resulting reaction mix is transferred from the second functional module of the second partial network to the first functional module of the second partial network.

In the substep 1140 of reproduction, in this embodiment example at least one amplification reaction is performed in order to amplify sample material present in the reaction mix. Reproduction is performed in particular using the first functional module of the second partial network as well as a plurality of the following elements: microfluidic valves, microfluidic pumping chambers. Reproduction is performed, by way of example only, by a polymerase chain reaction. In another embodiment example, the reproduction can also be performed by an isothermal amplification method. As part of the substep of reproduction, the microfluidic pumping chambers in which the reaction mix is present can therefore also be tempered in order to create suitable physical conditions that enable the amplification reaction to take place.

In the substep 1145 of acquisition, in this embodiment example a signal is acquired in order to verify the occurrence of at least one amplification reaction as part of the substep 1140 of reproduction. The signal is, by way of example only, an optical signal, e.g., a fluorescence signal emanating from at least one fluorescent dye indicative of the occurrence of at least one amplification reaction. In another embodiment example, the substep 1145 of acquisition can be performed at the same time as the substep 1140 of reproduction, or after the substep 1140 of reproduction. Optionally, during the substep 1145 of acquisition, output of the signal or a variable derived therefrom is also performed to output the result of the sample analysis performed in the microfluidic analysis device to a user.

In further embodiments of the method, individual substeps can be omitted and/or performed repeatedly or interchanged in sequence with other steps as described in the following embodiment examples, by way of example.

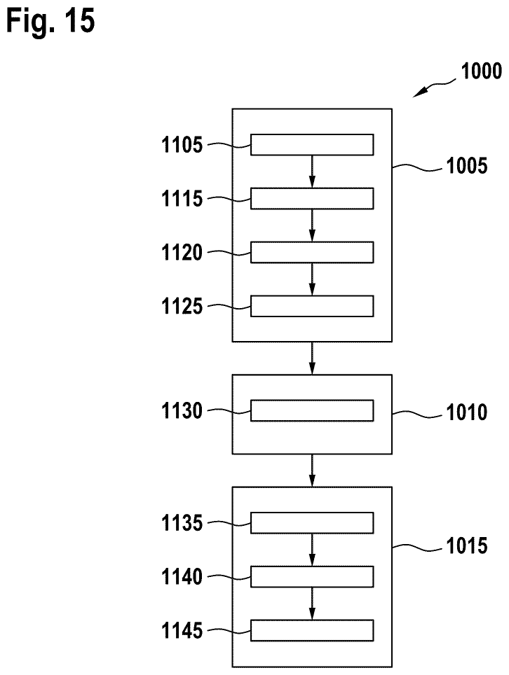

FIG. 15 shows a flow chart of a method 1000 for operating a microfluidic device according to an embodiment example. The method 1000 shown here corresponds to or is similar to the method described in the preceding FIGS. 13 and 14. In this variant of the method 1000, the substeps 1105 of mixing, 1115 of lysis, 1120 of filtering, 1125 of rinsing, 1130 of elution, 1135 of dissolving, 1140 of reproduction, and 1145 of acquisition are performed successively.

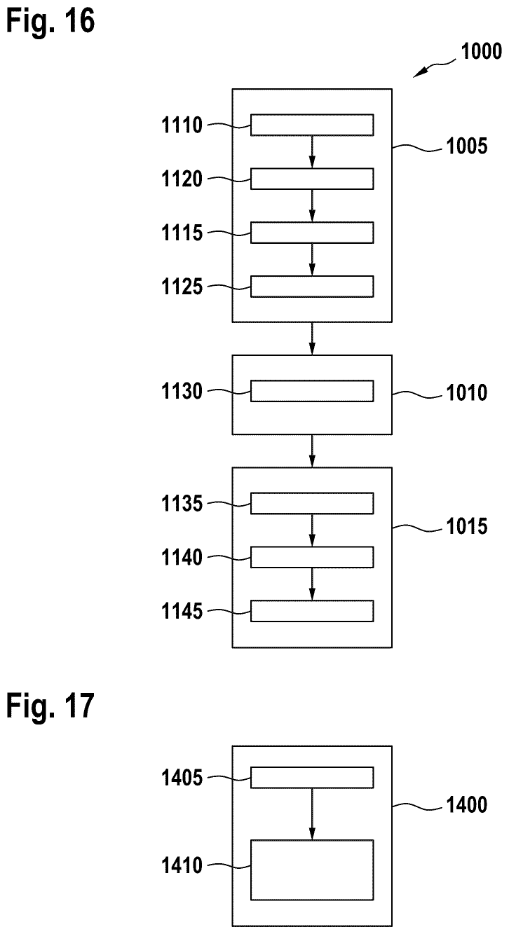

FIG. 16 shows a flow chart of a method 1000 for operating a microfluidic device according to an embodiment example. The method 1000 shown here corresponds to or is similar to the method described in the preceding FIGS. 13, 14 and 15. In this variant of the method 1000, the substeps 1110 of dissolving, 1120 of the filtering, 1115 of lysis, 1125 of rinsing, 1130 of elution, 1135 of dissolving, 1140 of reproduction, and 1145 of acquisition are performed successively.

FIG. 17 shows schematic view of an embodiment example of an analysis device 1400 for receiving a microfluidic device. The analysis device 1400 is designed, by way of example only, to receive a microfluidic device by way of an input port 1405 as described in the preceding FIGS. 1 to 12 to perform analysis processes within the device. In this embodiment example, the analysis device 1400 comprises a control device 1410 designed to control the method steps described in the preceding FIGS. 13 to 16 with respect to the device.

What is claimed is:

1. A microfluidic device for analyzing sample material, comprising:
a microfluidic network with a first partial network configured to purify sample material,
wherein the first partial network comprises a first functional module for providing liquid reagents, a second functional module for adding a sample substance, a third functional module for filtering sample material, a fourth functional module for storing a liquid, and a first microfluidic pumping chamber, and a second microfluidic pumping chamber for producing a fluid transport, and
wherein the first microfluidic pumping chamber and the second microfluidic pumping chamber are connected in series to the third functional module for filtering sample material.

2. The microfluidic device according to claim 1, further comprising a second partial network connected to the first partial network by a connection duct for amplifying sample material,
wherein the first partial network and the second partial network are separable from each other, and
wherein the second partial network comprises at least a first functional module for amplifying sample material and a second functional module for dissolving at least one amplification reaction bead.

3. The microfluidic device according to claim 1, wherein the first partial network and the second partial network are arranged in a linear topology.

4. The microfluidic device according to claim 1, further comprising:
a control connection configured to apply a first pressure to the first microfluidic pumping chamber; and
a control connection configured to apply a second pressure to the second microfluidic pumping chamber, to cause, by pressurizing the first microfluidic pumping chamber and aspirating with the second microfluidic pumping chamber, a pressure difference at the third functional module for filtering sample material.

5. A microfluidic device according to claim 1, wherein a first connection of the first microfluidic pumping chamber is connected to the first functional module for providing liquid reagents as well as the second functional module for adding a sample substance, a second connection of the first microfluidic pumping chamber with a first connection of the third functional module for filtering sample material, a first connection of the second microfluidic pumping chamber is connected to the second functional module for adding of a sample substance and a second connection of the second microfluidic pumping chamber is connected to a second connection of the third functional module for filtering sample material.

6. The microfluidic device according to claim 5, wherein the third functional module comprises a filter element which is separably connected to the first connection of the third functional module and separably connected to the second connection of the third functional module, as well as at least one microfluidic valve connected between the first and the second connection of the third functional module.

7. The microfluidic device according to claim 5, wherein:
the second functional module comprises a sample input chamber for adding a sample substance,
the sample input chamber is separably connected to a first connection of the second functional module and separably connected to a second connection of the second functional module, and
the first connection of the first microfluidic pumping chamber is connected to the first connection of the second functional module and the first connection of the second microfluidic pumping chamber is connected to the second connection of the second functional module.

8. The microfluidic device according to claim 2, further comprising a common control connection for applying pressure, wherein the common control connection is connected via a first control duct to an element of a functional module of the first partial network and via a second control duct to an element of the functional module of the second partial network.

9. The microfluidic device according to claim 2, wherein the first partial network includes a first shutoff valve configured to close the connection channel, and/or the second partial network features a second shutoff valve configured to close the connection channel.

10. The microfluidic device according to claim 9, further comprising a valve control connection for applying pressure, wherein the first shutoff valve and the second shutoff valve are configured to be controlled by way of the valve control connection.

11. The microfluidic device according to claim 1, wherein the fourth functional module of the first partial network is designed to output a liquid with sample material.

12. The microfluidic device according to claim 1, wherein:
the first partial network includes an additional fourth functional module configured to store a liquid, and
the first microfluidic pumping chamber is connected in parallel with the additional fourth functional module.

13. A method for operating the microfluidic device of claim 1, comprising:
extracting sample material using the first partial network,
wherein the extracting step includes a substep of filtering, in which a pressure difference is generated on the third functional module by combined pressurization of the first microfluidic pumping chamber and aspiration with the second microfluidic pumping chamber to cause filtering of sample material.

14. The method according to claim 13, further comprising:
transferring sample material from the first partial network to the second partial network; and
amplifying sample material using the second partial network.

15. The method according to claim 14, wherein:
the extracting step includes a substep of mixing and/or a substep of dissolving and/or a substep of lysis and/or a substep of rinsing, and/or
the transferring step includes a substep of elution, and/or
the amplifying step includes a substep of dissolving, and/or a substep of reproduction, and/or a substep of acquisition.
